(19) United States
(12) Patent Application Publication
(10) Pub. No.: US 2008/0158437 A1
(43) Pub. Date: Jul. 3, 2008

(54) Method for displaying digital image data and digital color display apparatus

(76) Inventors: Kazuma Arai, Tokyo (JP); Fusao Ishii, Menlo Park, CA (US); Yoshihiro Maeda, Tokyo (JP)

Correspondence Address: Bo-In Lin, 13445 Mandoli Drive, Los Altos Hills, CA, 94022, US

(21) Appl. No.: 12/005,540

(22) Filed: Dec. 26, 2007

Related U.S. Application Data
(60) Provisional application No. 60/877,323, filed on Dec. 27, 2006.

(51) Int. Cl. G09G 3/34

(52) U.S. Cl. 348/742

(57) ABSTRACT

The invention provides a display method using a plurality of subfields, the method including the step of splitting image data into N segments and distributing the intensity information on the image data in such a way that in a plurality of subfields that form a one-frame display period, the integrals of display light to be displayed in M (M≧2) subfields are substantially the same, wherein in the splitting and distributing step, each of at least M split data has the LSB (least significant bit) is equal to the weight of the bit of the image data having the weight of the bit close to the (N−1).

### CROSS REFERENCE

This application claims the benefit of priority by a previously filed U.S. Provisional Patent Application Ser. No. 60/877,323 filed on Dec. 27, 2006, the entire contents of which are incorporated by reference in this Application.

### BACKGROUND OF THE INVENTION

1. Field of the Invention

The present invention relates to a technology for splitting digital image data and a technology for displaying the data in color. For example, the invention relates to a technology effective when applied to a color display technology and the like by which a color separation optical part is used to produce display light of three primary colors of light in a time series manner, which are then combined into a color video signal.

2. Description of the Related Art

U.S. Pat. No. 6,275,271 discloses a technology for displaying video in color by applying R/G/B (Red/Green/Blue) display light beams generated by carrying out a color separation operation by using an optical device such as a color wheel. The display light beams of different colors are projected to a spatial light modulator (SLM), generally referred to as a DMD (Digital Mirror Device), in a time sequential manner for projecting the reflected light modulated by the SLM onto a screen or other kinds of image display surfaces.

Conventional method applies a pulse width modulation (PWM) process for driving the mirror element wherein each mirror element corresponds to one pixel in the DMD. The mirror element is switched between ON state for displaying image and the OFF state for projecting the light away from the image display lens. The switching operation is controlled according to the pulse waveform of one-frame input of the digital video data representing the intensity of each color as shown in FIG. 1.

In viewing a display image the viewer visually combines the R/G/B color images to perceive an integrated color image. In this process, it is necessary to switch the display light among the R/G/B colors in a time series manner at a certain minimum rate or faster. A switching below the required minimum rate causes a color breakup problem perceived by the viewer. Color breakup is a phenomenon caused by insufficient R/G/B color integration and hence the video image is displayed with three separate colors.

To address this problem, it is necessary to rotate the color wheel described above multiple times in a one-frame period to prevent the problem of color breakup. To perform such control, it is necessary to split the R/G/B input digital video data of each frame into a plurality of subfields for each color according to the rotation speed of the color wheel and control the operation of each mirror element in the SLM in each of the subfields.

However, when one-frame input digital video data is divided into a number of subfields, the ON periods of the mirror element corresponding to the intensity displayed in each of the subfields may differ from one another depending on the intensity information distribution along the temporal axis of the input digital video data. For these reasons, there are still technical difficulties confronted by the designers of an image display system to resolve the color breakup problem.

U.S. Pat. No. 6,275,271 discloses a grayscale display method. In this method, a frame/field corresponding to a predetermined color is formed with a plurality of time bands, i.e., time segments, and each of the segments is divided into a plurality of subfields. By changing the weight in each of the subfields in each of the segments, the degree of change in grayscale among the plurality of subfields in the display period becomes small when the grayscale of a display image changes. There is no pseudo contour and hence the image quality improves.

In this patented method, however, a color breakup may still occur due to the variation in intensity in the subfields when one frame is split into a plurality of subfields for display. Therefore, there is a need to provide a solution to overcome the above-discussed color breakup problems.

### SUMMARY OF THE INVENTION

An object of the invention is to provide a color display technology by which excellent color image display without color breakup can be achieved.

A first aspect of the invention provides a display method using a plurality of subfields, the method including the step of:

Splitting image data into N segments and distributing the intensity information on the image data in such a way that in a plurality of subfields that form a one-frame display period, the integrals of display light to be displayed in M (M≧2) subfields are substantially the same, wherein in the splitting and distributing step, each of at least M split data has the LSB (least significant bit) is equal to the weight of the bit of the image data having the weight of the bit close to the (N−1).

A second aspect of the invention provides a color display method using a plurality of subfields for display light having at least two colors, the method including the step of:

splitting image data on each of the colors into N segments and distributing the intensity information on the image data in such a way that in a plurality of subfields that form a one-frame display period, the integrals of the display light to be displayed in M (M≧2) subfields are substantially the same,

wherein in the splitting and distributing step, each of at least M split data has data values equal to the superior bits of the image data, the LSB (least significant bit) of the M split data is the bit of the image data having the weight of the bit close to the (N−1), and

the intensity information on each of the colors is distributed in such a way that the proportion of the integrated amount of the display light to be displayed in the subfields that form the M fields for each of the colors is substantially the same as the proportion of the intensity information on each of the colors in the image data.

A third aspect of the invention provides the method for displaying image data according to the first or second aspect, wherein in the splitting and distributing step, the intensity information to be distributed to each of the subfields is converted into data containing a bit row formed of bits having the same weight, a successive part of the bits having the same value, and the converted intensity information is distributed to each of the subfields.

A fourth aspect of the invention provides the method for displaying image data according to the first or second aspect, wherein in the splitting and distributing step, when the intensity information on the image data is distributed to S subfields, the intensity information is split into at least 2ⁿ (N=2ⁿ), and when the split intensity information is distributed to the S subfields, the n is an integer next to log₂S.

A fifth aspect of the invention provides the method for displaying image data according to the first aspect, wherein the integrals of the display light in the subfields having substantially the same integral of the display light are greater than the integrals of the display light in the other subfields.

A sixth aspect of the invention provides a display apparatus including:

a light source that produces illumination light;

a deflection mirror device that modulates the illumination light from the light source;

a controller that uses intensity information on image data to control the deflection mirror device, the controller having a function of distributing the intensity information in such a way that in a plurality of subfields that form a one-frame display period, the integrals of projection light to be displayed in M (M≧2) subfields are substantially the same, the controller further including a data splitter that splits the image data in such a way that each of at least (N−1) (N (natural number)≧2) split data has the LSB (least significant bit) is equal to the weight of the bit of the image data having the weight of the bit close to the N.

A seventh aspect of the invention provides the display apparatus according to the sixth aspect, wherein the controller further includes a data converter that converts the intensity information on the image data to be distributed to each of the subfields into data containing a bit row formed of bits having the same weight, a successive part of the bits having the same value.

An eighth aspect of the invention provides the display apparatus according to the sixth aspect, the apparatus further including

color filters disposed along the light path of projection light or illumination light, the color filters having functions of filtering a plurality of colors in such a way that the projection light is changed in a time series manner, and

a color filter controller that controls and changes the timing for projecting different colors of the projection light.

A ninth aspect of the invention provides the display apparatus according to the sixth aspect, wherein the light source is a variable-power light source, such as an optical laser, and

the controller converts the distributed image data according to the intensity of the illumination light in such a way that the integrals of the projection light to be displayed in the subfields are fixed.

A tenth aspect of the invention provides the display apparatus according to the sixth aspect, wherein the deflection mirror device has at least three deflection states, and

the controller converts the distributed image data according the deflection state of the deflection mirror device in such a way that the integrals of the projection light to be displayed in the subfields are fixed.

An eleventh aspect of the invention is a method for displaying image data using a plurality of subfields, the method including the step of:

distributing the intensity information on the image data in such a way that in a plurality of subfields that form a one-frame display period, the integrals of display light to be displayed in at least two of the subfields are substantially the same.

According to each of the above aspects of the invention, the subfield data for each color in each field is split into fields, each having the proportion of R/G/B intensity substantially equal to that of the input digital video data. As a result, an output image corresponding to and substantially equal to the input digital video data for each field is obtained, so that an image in accordance with the input digital video data can be outputted for each field, allowing image display with less color breakup.

Further, by converting the binary data into non-binary data in which the amount of intensity information is expressed by bits having equally weighed successive data (“1”, for example) and inputting the converted non-binary data to the spatial light modulation device, it is possible to prevent generation of a pseudo contour.

### BRIEF DESCRIPTION OF THE FIGURES

FIG. 1 is a waveform diagram showing one-frame input digital video data for a certain color in conventional pulse width modulation;

FIG. 2 is a conceptual view showing the configuration of a projection display apparatus, which is an example of the color display apparatus for implementing the color display method, which is an embodiment of the invention;

FIG. 3 is a block diagram showing an exemplary configuration of a control system in the projection display apparatus, which is an embodiment of the invention;

FIG. 4 is a conceptual view showing an example of the configuration of a spatial light modulation device that is part of the projection display apparatus, which is an embodiment of the invention;

FIG. 5 is a conceptual view showing an exemplary configuration of each pixel in the spatial light modulation device, which is an embodiment of the invention;

FIG. 6 is a cross-sectional view showing an exemplary configuration of each pixel in the spatial light modulation device, which is an embodiment of the invention;

FIG. 7 is a conceptual view for explaining an example of the operation of the spatial light modulation device, which is an embodiment of the invention;

FIG. 8 is a conceptual view for explaining an example of the operation of the spatial light modulation device, which is an embodiment of the invention;

FIG. 9 is an explanatory view showing an example of the operation of the color display apparatus for implementing the color display method, which is an embodiment of the invention;

FIG. 10 is a conceptual view showing an example of the configuration of a projection display apparatus as the projection display system, which is another embodiment of the invention;

FIG. 11 is a block diagram showing an exemplary configuration of the control system of the projection display apparatus, which is another embodiment of the invention;

FIG. 12 is a conceptual view showing an example of the operation of the projection display apparatus, which is another embodiment of the invention;

FIG. 13 is a conceptual view for explaining an example of the operation of the spatial light modulation device, which is an embodiment of the invention;

FIG. 14A is a conceptual view showing the ON-position deflection state of the mirror of the spatial light modulation device, which is another embodiment of the invention;

FIG. 14B is a diagrammatic view showing the waveform of the deflection control voltage that controls the ON-position deflection state of the mirror of the spatial light modulation device, which is another embodiment of the invention;

FIG. 15A is a conceptual view showing the OFF-position deflection state of the mirror of the spatial light modulation device, which is another embodiment of the invention;

FIG. 15B is a diagrammatic view showing the waveform of the deflection control voltage that controls the OFF-position deflection state of the mirror of the spatial light modulation device, which is another embodiment of the invention;

FIG. 16A is a conceptual view showing intermediate-position deflection states of the mirror of the spatial light modulation device, which is the other embodiment of the invention;

FIG. 16B is a diagrammatic view showing the waveform of the deflection control voltage that controls the intermediate-position deflection states of the mirror of the spatial light modulation device, which is another embodiment of the invention;

FIG. 17A is a conceptual view showing intermediate-position deflection states of the mirror of the spatial light modulation device, which is another embodiment of the invention;

FIG. 17B is a diagrammatic view showing the waveform of the deflection control voltage that controls the intermediate-position deflection states of the mirror of the spatial light modulation device, which is another embodiment of the invention;

FIG. 18 is a conceptual view showing an exemplary configuration of a projection display apparatus having a plurality of spatial light modulation devices (SLMs);

FIG. 19 is a block diagram showing an exemplary configuration of the control system of the projection display apparatus having a plurality of spatial light modulation devices (SLMs); and

FIG. 20 is a conceptual view showing an example of the operation of the projection display apparatus having a plurality of spatial light modulation devices (SLMs).

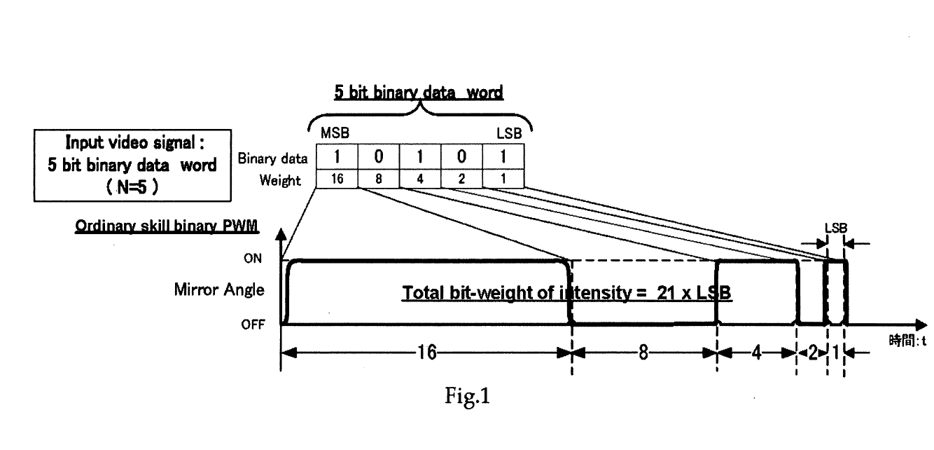

### DESCRIPTION OF THE PREFERRED EMBODIMENT

Embodiments of the invention will be described below in detail with reference to the drawings.

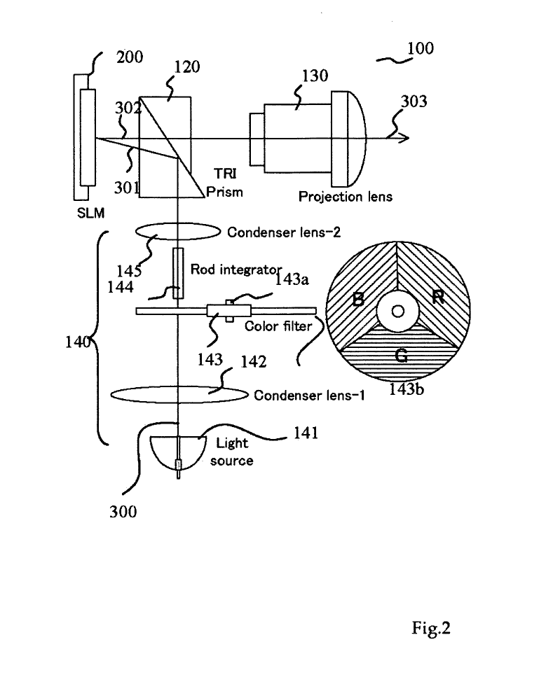

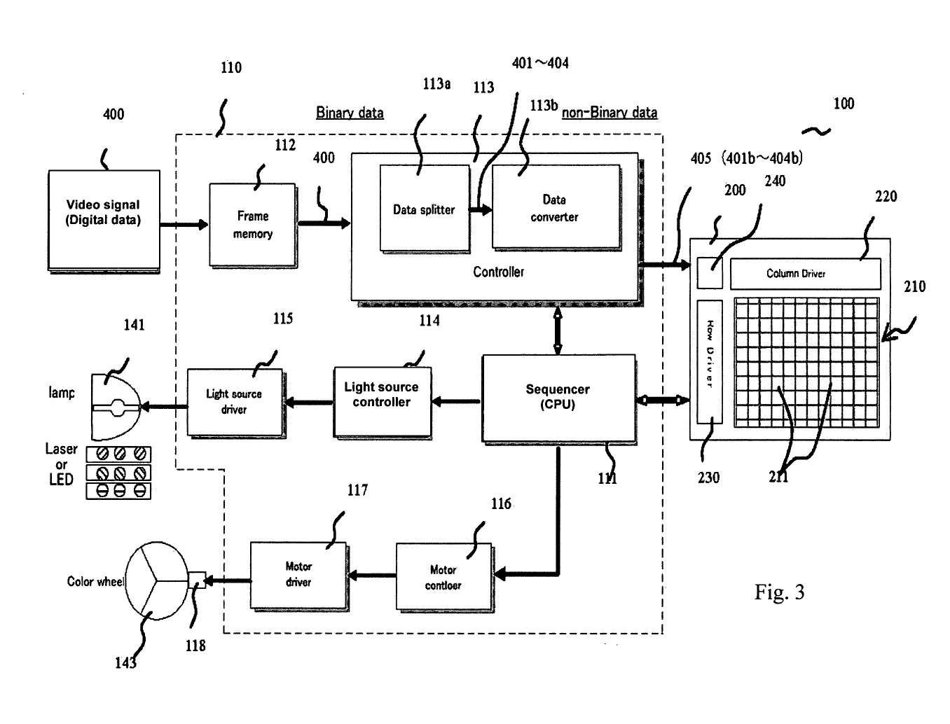

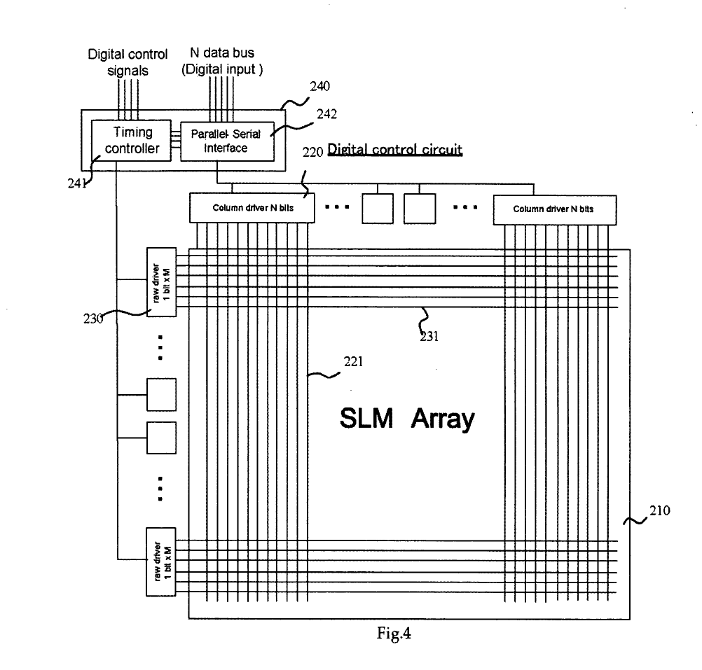

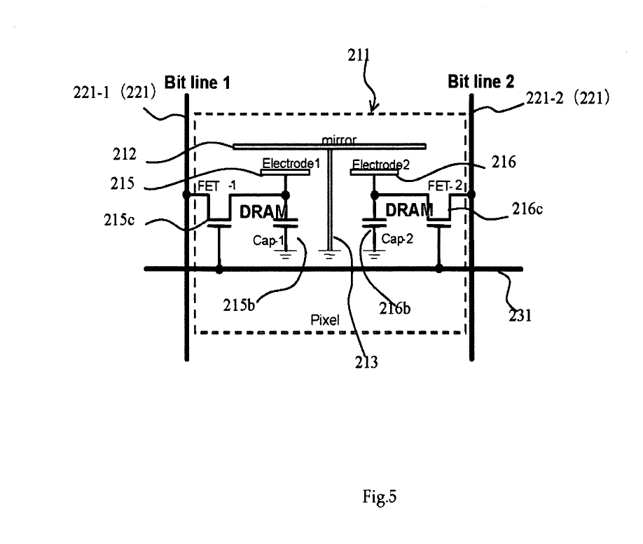

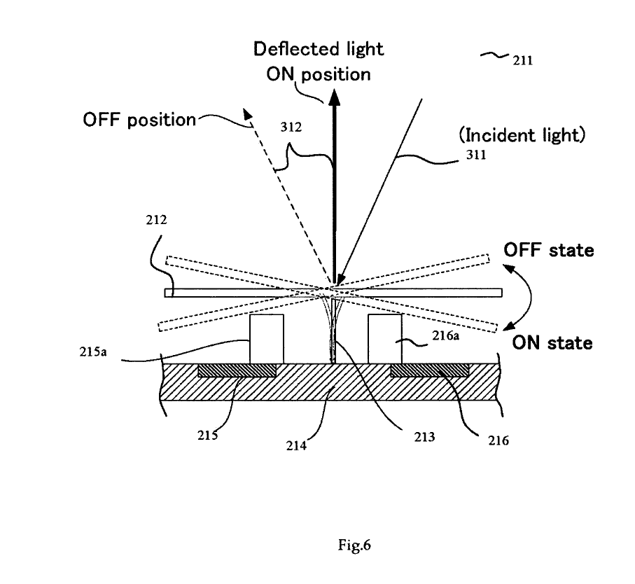

FIG. 2 is a functional block diagram for presenting a conceptual view showing the configuration of a projection display apparatus 100, which is an example of the color display apparatus for implementing the color display method according to an embodiment of the invention. FIG. 3 is a block diagram showing an exemplary configuration of a control system in the projection display apparatus 100 of this embodiment. FIG. 4 is a circuit schematic diagram for presenting a conceptual view showing an example of the configuration of a spatial light modulation (SLM) device 200 that is part of the projection display apparatus 100 of this embodiment. FIG. 5 is a cross sectional view for presenting the functional features of components of an exemplary configuration of each pixel in the spatial light modulation device 200 of this embodiment. FIG. 6 is a cross-sectional view showing an exemplary configuration of each pixel in the spatial light modulation device 200.

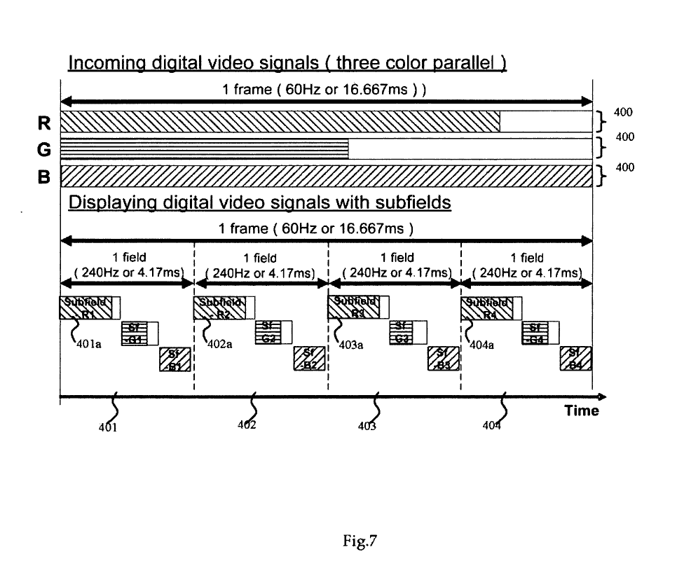

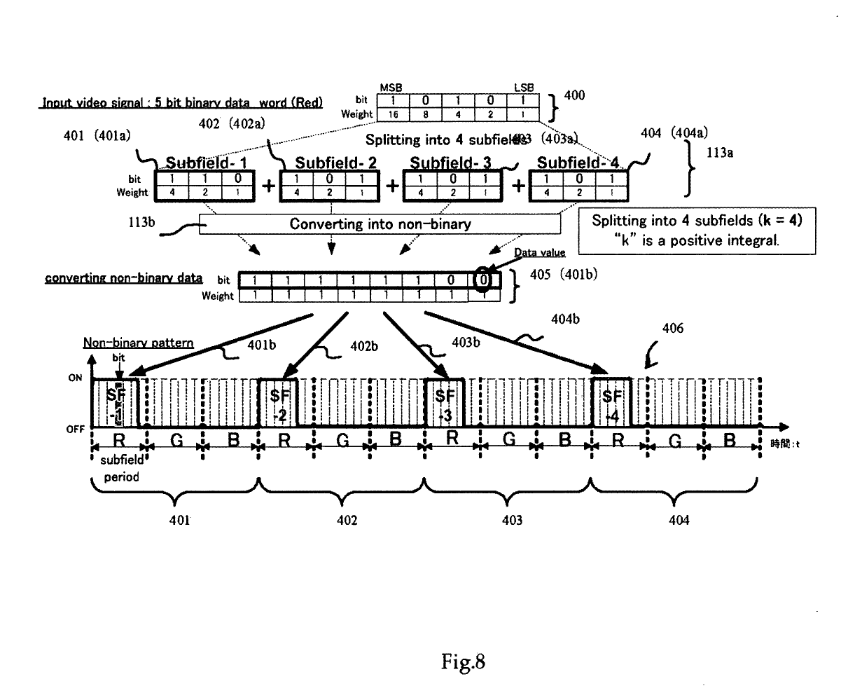

FIGS. 7 and 8 are diagrams to illustrate the application of video signals in applying the video signals in a time divisional control schemes implemented in the spatial light modulation device 200 of this embodiment.

As illustrated in FIG. 2, the projection display apparatus 100 of this embodiment includes a spatial light modulation (SLM) device 200, a control unit 110, a TIR prism 120, a projection optical system 130, and a light source optical system 140.

The spatial light modulation device 200 and the TIR prism 120 are disposed along the optical axis of the projection optical system 130. The light source optical system 140 is disposed with an optical axis perpendicular to the optical axis of the projection optical system 130.

The light source optical systems are disposed immediate next to the TIR prism 120. The TIR prism 120 allows the illumination light 300 projecting from the light source optical system 140 to project from the TIR prism 120 as incident light 301 onto the spatial light modulation device 200 at a predetermined oblique angle. A reflected light 302 is reflected from the SLM device 200 along a perpendicular direction from the spatial light modulation device 200 to pass through the TIR prism 120 and then projects into the the projection optical system 130.

The projection optical system 130 projects the reflected light 302 modulated by the spatial light modulation device 200 through the TIR prism 120 onto a screen or the like (not shown) as projection light 303.

The light source optical system 140 includes a light source 141 that produces the illumination light 300, a condenser lens 142 that collects the illumination light 300, a rod integrator 144, a condenser lens 145, and a color wheel 143.

The light source 141, the condenser lens 142, the color wheel 143, the rod integrator 144, and the condenser lens 145 are sequentially disposed along the optical axis of the illumination light 300 projected out from the light source 141 onto the side of the TIR prism 120.

The color wheel 143 has a structure with divided R/G/B color filter sectors, each occupies an area over predefined radial angle and arranged around the rotating shaft 143a in the rotating direction.

In the color wheel 143, the rotating shaft 143a is located at a position apart from the light path of the illumination light 300 so that the illumination light 300 passes through the color filter 143b. By rotating the color filter 143b around the rotating shaft 143a at a predetermined speed, illumination light 300 passing through the color filter 143b is filtered in a time sequential manner according to a predetermined repeated cycles so that only a single color of R illumination light 300, G illumination light 300, and B illumination light 300 is transmitted within a specified time duration. The single color illumination light is then applied to the spatial light modulation device 200 as the incident light 301 through the TIR prism 120.

In this embodiment, although the color wheel 143 is disposed in the light source optical system 140 before the light reaches the spatial light modulation device 200, the color wheel 143 can be disposed in the projection optical system 130 to process the light after the SLM device 200 modulates the light.

The control unit 110 includes a sequencer 111, a frame memory 112, a controller 113, a light source controller 114, a light source driver 115, a motor controller 116, and a motor driver 117.

The sequencer 111 is implemented on a microprocessor or similar devices to control the operation timings and related operational parameters of the entire system including the control unit 110 and the spatial light modulation device 200.

The frame memory 112 holds input digital video data 400 coming from an external apparatus (not shown). The amount of data stored in the frame memory is typically for image display of one frame. The input digital video data 400 is periodically updated whenever display of one frame is completed.

The controller 113 processes the input digital video data 400 read from the frame memory 112 in a manner described later. The controller 113 outputs the processed data to the spatial light modulation device 200 as non-binary data 405.

The light source controller 114 controls the light emission operation of the illumination light 300 in the light source 141 via the light source driver 115 based on an instruction received from the sequencer 111.

The motor controller 116 drives and rotates a wheel drive motor 118 via the motor driver 117 based on an instruction from the sequencer 111. The motor controller 115 controls the rotation speed, the rotation timing and the like in the rotation operation of the color wheel 143 attached to the wheel drive motor 118 via the rotating shaft 143a.

As illustrated in FIGS. 3 and 4, the spatial light modulation device 200 of this embodiment includes a pixel array 210, a column driver 220, a row driver 230, and an external interface 240.

The external interface 240 includes a timing controller 241 and a parallel-serial converter 242. The timing controller 241 controls the row driver 230 based on the timing signal from the sequencer 111. The parallel-serial converter 242 supplies non-binary data 401b to 404b coming from the controller 113 to the column driver 220.

In the pixel array 210, a plurality of pixels 211 are disposed in a grid at the positions where the bit lines 221 vertically extends from the column driver 220 to intersect word lines 231 laterally extended from the row driver 230.

As illustrated in FIGS. 5 and 6, each of the pixel elements 211 includes a mirror 212 supported on a substrate 214 via a hinge 213 allowing the mirror 212 the flexibility to tilt to different deflection angles.

An OFF electrode 215/an OFF stopper 215a and an ON electrode 216/an ON stopper 216a on opposite sides of the hinge 213 in a symmetric manner are disposed on the substrate 214.

A predetermined potential is applied to the OFF electrode 215 to produce a coulomb force, which draws and tilts the mirror 212 until it contacts the OFF stopper 215a. Then, the incident light 311 projected on the mirror 212 is reflected toward an OFF-position light path away from the optical axis of the projection optical system 130.

A predetermined potential is applied to the ON electrode 216 to produce a coulomb force, which draws and tilts the mirror 212 until it contacts the ON stopper 216a. Then, the incident light 311 projected on the mirror 212 is reflected toward an ON-position light path that coincides with the optical axis of the projection optical system 130.

As illustrated in FIG. 5, the OFF electrode 215 is connected to an OFF capacitor 215b, which is then connected to the bit line 221-1 and the word line 231 via a gate transistor 215c.

The ON electrode 216 is connected to an ON capacitor 216b, which is then connected to the bit line 221-2 and the word line 231 via a gate transistor 216c.

The gate transistor 215c and the gate transistor 216c are controlled to switch the transistor to operated as opened and closed circuit by a signal received from the word line 231.

A row of pixels 211 connected to an arbitrary word line 231 are simultaneously selected, and the bit lines 221-1 and 221-2 are used to charge and discharge the OFF capacitor 215b and the ON capacitor 216b, so that the mirror 212 in each of the pixels 211 in the row is individually controlled.

In the embodiment illustrated in FIG. 3, the controller 113 in the control unit 110 includes a data splitter 113a and a data converter 113b.

The data splitter 113a in this embodiment splits the input digital video data 400 into a plurality of subfields 401 to 404. In this process, the data splitter 113a distributes one-field intensity information on each color contained in the original input digital video data 400 to the plurality of subfields 401 to 404 in substantially a uniform manner.

The data converter 113b converts binary data 401a to 404a in each of the plurality of subfields 401 to 404 generated in the preceding splitting process into non-binary data 405, i.e., the non-binary data 401b to 404b, which is a bit row containing bits having the same weight, for example one. The converter further converts a successive part of the bits corresponding to the intensity value having a value of “1”.

In this embodiment, as described above, the illumination light 310 projected out from the light source 141 passes through the color wheel 143 having the R/G/B (Red/Green/Blue) color filtering sectors to apply the incident light beams 311 in a time series manner to the spatial light modulation device 200. The SLM device 200 controls the mirror 212 in each pixel 211 for desired image display according to the input digital video data 400 representing the RIG/B intensity values to achieve color display by using one spatial light modulation device 200, which.

In this case, in the eyes of the viewer the R/G/B colors are visually combined to perceive the color image. In this process, it is necessary to switch the illumination light 310, i.e., the incident light 311, among the R/G/B colors in a time sequential manner equal to or faster than a certain rate. A color break problem may occur when the switching speed is lower than a required rate based on the visual perception of the human eyes.

In order to resolve this problem, the color wheel 143 is rotated multiple times in a one-frame display period to prevent the generation of color breakup. Alternatively, a color wheel 143 having multiple sets of R/G/B regions may be implemented to provide a similar advantageous effect.

FIG. 7 illustrates the division of the R/G/B input digital video data 400 of each frame into a plurality of subfields, i.e., subfileds 401 to 404, according to the rotation speed of the color wheel 143. The mirror 212 in each pixel 211 in the spatial light modulation device 200 is controlled according to a time divisional control scheme for each of the subfields.

However, when the input digital video data 400 for each color is simply divided by the number of subfields in a time sequential manner, the intensity values in the subfields vary greatly from one subfield to another depending on the state of the input data, resulting in color breakup due to the intensity variations among the subfields.

In this embodiment, the problem is resolved. When the data splitter 113a in the controller 113 splits the input digital video data 400 representing the R/G/B intensity into the plurality of subfields 401 to 404, the intensity information on each color is distributed to the plurality of subfields in a substantially uniform manner.

FIG. 8 shows a specific example of a method for distributing the intensity information on each color to the subfields 401 to 404 in this embodiment. In the example shown in FIG. 8, the red (R) input digital video data 400 (five bits) is split into binary data 401a, binary data 402a, binary data 403a, and binary data 404a corresponding to the four subfields 401 to 404. Each subfield has the same display period as shown in FIG. 7.

However, by inputting the data in the binary form to the spatial light modulation device 200, a pseudo contour may be generated when the viewer quickly moves his/her sight line on the display screen. Accordingly, in this embodiment, the data converter 113b further converts the binary data 401a to 404a into non-binary data 405 (non-binary data 401b to 404b) in which the weight of each bit is one, and the converted non-binary data are inputted to the spatial light modulation device 200.

The following paragraphs describe the processing steps applied in the data splitter 113a and the data converter 113b (included in the controller 113 of FIG. 3), split the input digital video data 400 into the plurality of subfields 401 to 404 (distributing the intensity information to binary data 401a to 404a) and convert the binary data 401a to 404a in the plurality of subfields 401 to 404 into the non-binary data 405 (non-binary data 401b to 404b) as illustrated in FIG. 8.

The binary input digital video data 400 according to each display pixel is temporarily stored in the frame memory 112. The digital video data is sequentially split in the data splitter 113a (data splitter) in the controller 113 into the four binary data 401a, binary data 402a, binary data 403a, and binary data 404a in such a way that the intensity values displayed in the subfields 401 to 404 are substantially the same.

In this example of the splitting process, the original input digital video data 400 is shifted rightward by two bits and split into four equal segments, allocated to the subfields 401 to 404, respectively. Further, the overflowing two-bit data in the preceding rightward-shift operation is added to the binary data 401a corresponding to the first subfield 401.

In this way, the intensity information on the original one-frame input digital video data 400 (“21” in this example shown in FIG. 8) is distributed to the subfields, that is, “6” to the subfield 401 and “5” to the subfields 402 to 404.

The binary data thus split by the data splitter 113a (the binary data 401a to 404a) and converted in the data converter 113b in the controller 113 into the non-binary data 405 (non-binary data 401a, non-binary data 402b, non-binary data 403b, and non-binary data 404b) formed of a bit row containing a plurality of bits, each having the same weight of one. The converted non-binary data are continuously outputted from the same data values (in this case, this data value is “1”) to the spatial light modulation device 200.

In this example, the non-binary data 401b corresponding to the first subfield 401 is a bit row in which each of the successive first six bits has a value of one, and each of the non-binary data 402b to 404b corresponding to the following subfields 402 to 404 is a bit row in which the successive first five bits has a value of one.

As a result, each pixel 211 in the spatial light modulation device 200 is controlled, as shown in the non-binary pattern 406 in FIG. 8. The mirror 212 is continuously ON or OFF in the subfields 401 to 404 according to the non-binary data 401b to 404b.

In the configuration of the pixel 211 illustrated in FIG. 5, the column driver 220 supplies the signal (data) to the bit line 221-2. The signal has the waveform of the non-binary pattern 406 to drive the mirror 212 to the ON side, while generating and supplying the reversed non-binary pattern 406 (data) to the bit line 221-1 that drives the mirror 212 to the OFF side.

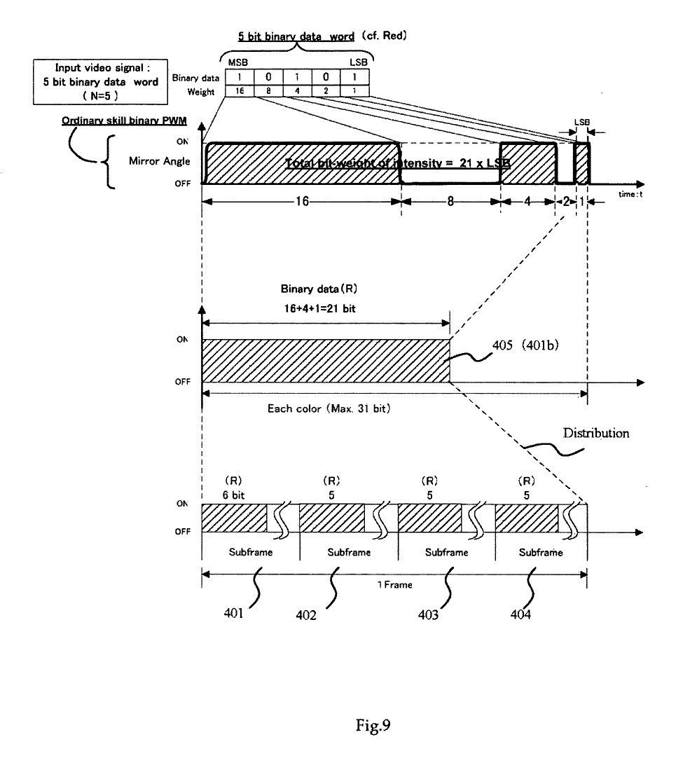

FIG. 9 is a diagram for explaining the comparisons between applying the conventional technology of pulse width modulation is on the input digital video data 400 versus this the techniques disclosed in this embodiment. This invention applies the intensity binary data 401a to 404a and distribute the binary data in a substantially uniform manner are allocated to the subfields 401 to 404.

In the conventional technology, the PWM processes are shown in the upper part of FIG. 9. The modulated waveform is split into four equal segments in the temporal axis. The ratios of the ON period to the OFF period in the split units (subfields) vary from one another.

On the other hand, in this embodiment shown in the lower part, the input digital video data 400 is converted into the non-binary data 405 in the form of a bit row in which the ON periods in one frame is forward-aligned. The non-binary data 405 is then split in such a way that the ratios of the ON period to the OFF period corresponding to the intensity distributions, in the plurality of subfields are substantially the same. The split non-binary data are distributed to the subfields in a substantially uniform manner. The intensity values in the subfields therefore do not have sudden and great variation from one subfield to another subfield.

According to this embodiment, the intensity data corresponding to the subfields 401 to 404 (binary data 401a to 404a and non-binary data 401b to 404b) for each color in each field are distributed to said each fields in such a way that each of the distributed data has proportions of R/G/B intensity values substantially equal to those in the input digital video data 400.

As a result, since an output image is substantially equal to the input digital video data 400 for each field, an image corresponding to the input digital video data 400 is displayed for each field thus reduces the effects of color breakup in displaying the color images.

Further, since the binary data 401a to 404a are converted into the non-binary data 401b to 404b when supplied to the spatial light modulation device 200, it is possible to prevent image quality degradation such as a pseudo contour in the display image due to abrupt variations in intensity information in the subfields 401 to 404.

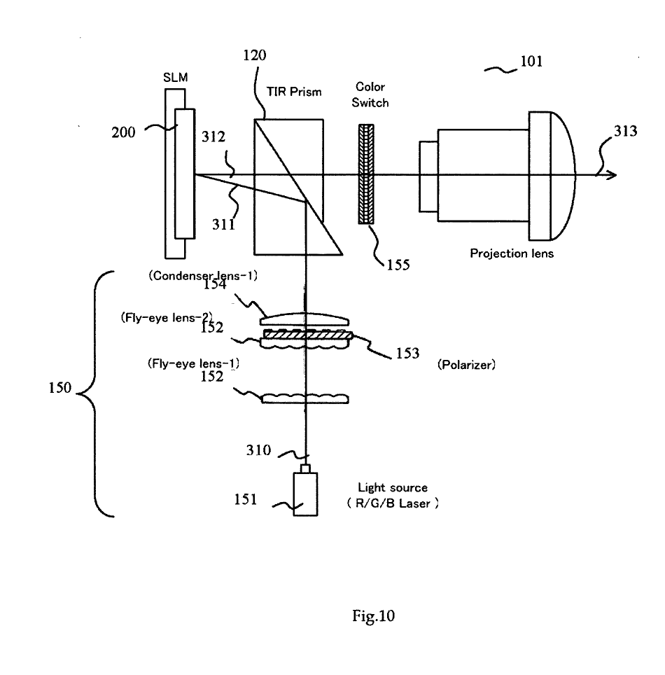

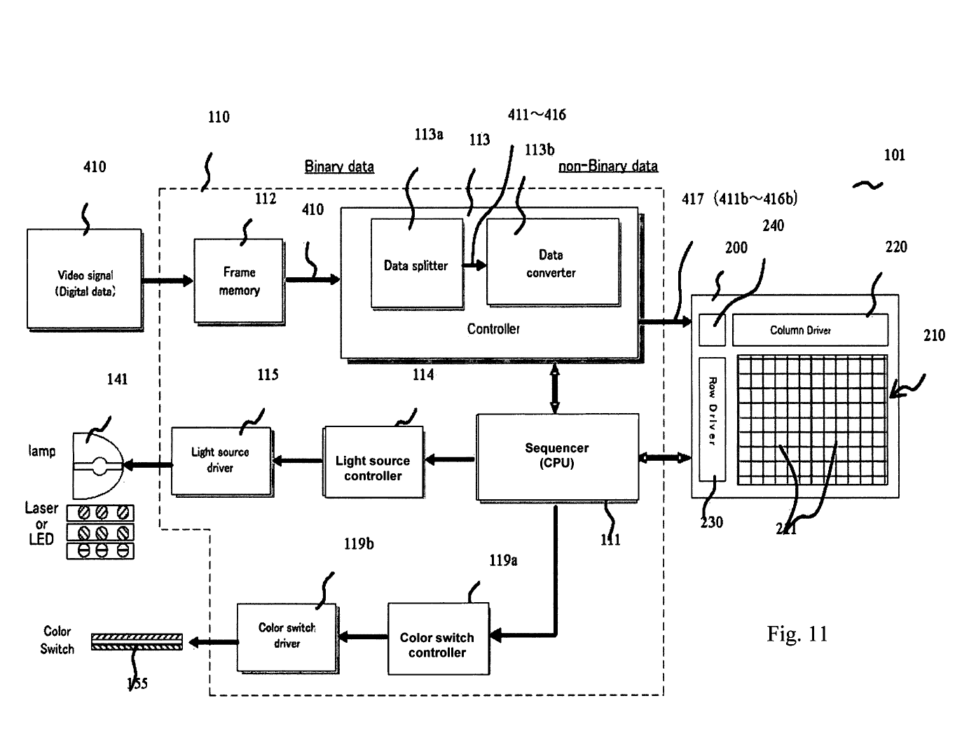

FIG. 10 is a system diagram for present a conceptual view for showing an exemplary configuration of a projection display apparatus 101 as the projection display system as another embodiment of the invention. FIG. 11 is a block diagram showing an exemplary configuration of the control system of the projection display apparatus 101 of this embodiment.

The projection display apparatus 101 of this embodiment differs from the projection display apparatus 100 described above in that the projection display apparatus 101 includes a light source 151, two fly-eye lenses 152, a polarizer 153, and a condenser lens 154 in a light source optical system 150, and a color switch 155.

By implementing these different optical components, the control unit 110 in the control system illustrated in FIG. 11 employs a color switch controller 119a and a color switch driver 119b for driving the color switch 155 instead of the motor controller 116 and the motor driver 117.

The two fly-eye lenses 152, the polarizer 153, and the condenser lens 154 are sequentially disposed along the light path of the illumination light 310 projected out from the light source 151 and reaches the TIR prism 120. The color switch 155 is disposed between the TIR prism 120 and the projection optical system 130.

The fly-eye lens 152 serves the function of smoothing the intensity distribution of the white illumination light beam 310 into a more uniform distribution.

The polarizer 153 changes the polarization angle of the illumination light 310 passed through the fly-eye lenses 152 to a predetermined polarization angle.

The illumination light 310 passes through the polarizer 153 to project to the spatial light modulation device 200 as the incident light 311. As a polarized light, the incident light 311 has a predetermined polarization angle. The reflected light 312 modulated by the spatial light modulation device 200 passes through the TIR prism 120, the color switch 155, and the projection optical system 130 as an image projection light 313.

The color switch 155 has a structure of stacked color filters, each transmitting the frequency band that corresponds to each of the colors R/G/B and has a predetermined polarization angle according to an externally applied voltage (not shown).

In this configuration, by controlling the reflected light 312 that passes through the color switch 155 at a controlled time duration, the reflected light 312 passes through the color switch 155 is filtered into one of the reflected R/G/B light beams as a single color projection light 313.

In this embodiment, the color switch 155 is disposed along the light path of the projection light 313 by way of example, it is understood that the color switch 155 can replace the color wheel 143 shown in FIG. 2 disposed at a downstream location along the light path of the illumination light 310 after the light passes through the polarizer 153.

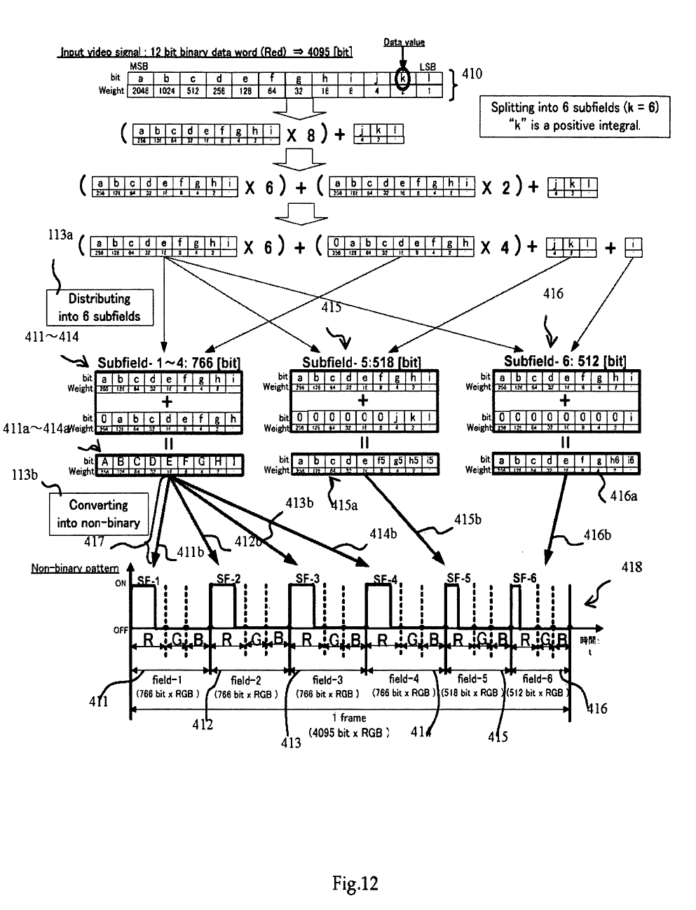

With the application of the color switch 155, the subfield period may be freely switched corresponding to an external signal, such as the input digital video data 400. As a result, one field can be split into subfields having different display periods as shown in FIG. 12.

FIG. 12 shows an exemplary process in which one field is split into six subfields by way of example.

The data splitter 113a in the controller 113 in FIG. 11 splits and distributes the intensity information included in the binary input digital video data 410, i.e., a 12 bits input data, into binary data 411a, binary data 412a, binary data 413a, binary data 414a, binary data 415a, and binary data 416a corresponding to four subfields 411 to 414, e.g., subfield-1 to subfield-4, having the same display period and two subfields 415 and 416, i.e., the subfield-5 and subfield-6, having different display periods.

The input digital video data 410 is split into eight equal segments, and each of two of the eight segments is further split into two equal segments. The resultant four split data are added to the first four segments (subfields 411 to 414) of the remaining six segments, respectively, to produce binary data 411a, binary data 412a, binary data 413a, and binary data 414a.

There are three reminder bits (j, k and l) of the input digital video data 410 left over after the above eight-segment splitting operation. These three bits are added to one subfield 415 of the last two remaining segments, i.e., subfields 415 and 416, of the six segments described above to produce binary data 415a, and the least significant bit (i), left over after the above two-segment splitting operation, is added to the last segment, i.e., subfield 416, to form the binary data 416a.

Further, the data converter 113b converts the binary data 411a to 414a, the binary data 415a, and the binary data 416a into non-binary data 417, i.e., non-binary data 411b, non-binary data 412b, non-binary data 413b, non-binary data 414b, non-binary data 415b, and non-binary data 416b. A bit row containing bits having the same weight, e.g., a weight of one in this case with a successive part of the bits corresponding to the intensity value having a value of “1” is generated. The converted non-binary data are outputted to the spatial light modulation device 200 as non-binary data pattern 418.

By using the color switch controller 119a and the color switch driver 119b described above, the switching operations is controlled among the different color transmissions based on the timings instructed by the controller 113 via the sequencer 111. The color switch 155 converts the deflected light, i.e., the reflected light 312, reflected off the spatial light modulation device 200 into R/G/B color projection light beams 313 according to the display periods of the subfields 411 to 414 and the subfields 415 and 416.

In this embodiment, the display period of each of the first four equal binary data 411a to 414a is controlled to be relatively longer (766 bits multiplied by R/G/B in this case). The display period of each of the remaining binary data 415a and 416a have relatively shorter duration (518 bits multiplied by R/G/B and 512 bits multiplied by R/G/B in this case).

As a result, the binary data 411a to 414a for each color in the subfields 411 to 414 are generated by splitting the input digital video data 410 into equal segments and by uniformly distributing the split data. An output image equal to the input digital video data 410 is obtained. Since the subfields 411 to 414 account for a large proportion of the one-frame display period, e.g., approximately 75% in this embodiment, excellent image display with less color breakup is achieved because of the reasons discussed above.

Alternatively, when the light source 151 is a variable-power light source having a plurality of output levels projecting variable amounts of light, and the output power levels change in each of the subfields 411 to 416, it is possible to control the conversion operation in the data converter 113b in such a way to maintain a constant light intensity for an integrated amount of light generated from changed illumination light 310.

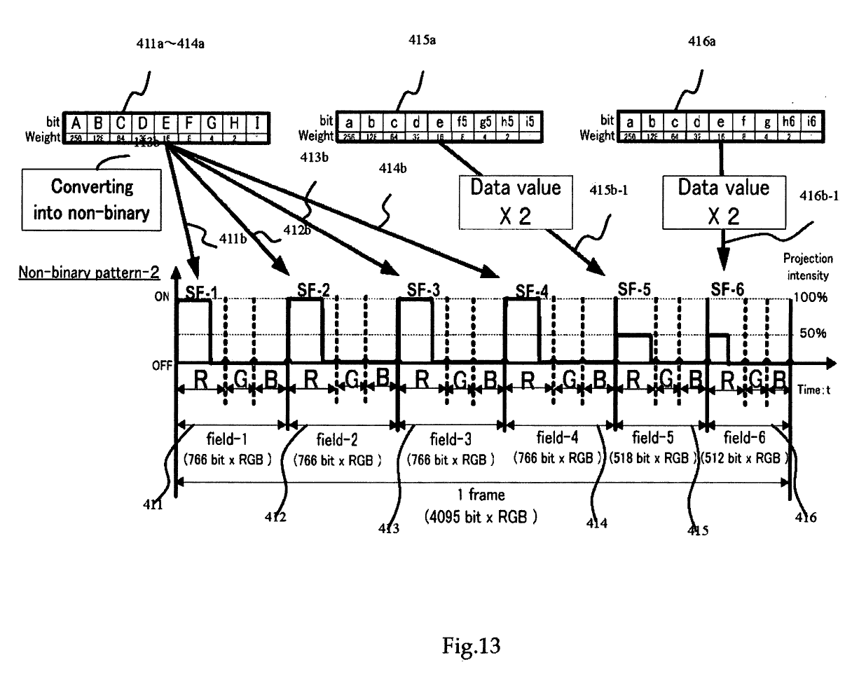

FIG. 13 is an exemplary control chart in which the amount of light from the light source 151, e.g., the illumination light 310, is halved (50%) in the last two subfields 415 and 416 in FIG. 12.

In this case, the data converter 113b corrects the values of the non-binary data 415b-1 and 416b-1 allocated to the last two subfields 415 and 416 by doubling those values. Alternatively, the period allocated to the unit bit in the non-binary data 415b-1 and 416b-1 may be changed. In the subfields 415 and 416, the broken line represents the pre-conversion waveform, and the solid line represents the post-conversion waveform.

By doubling the number of bits in the non-binary data in the subfields 415 and 416, the 50% reduction in the amount of light is compensated. The integrated intensity of the illumination light 310 in each of the subfields 415 and 416 is maintained and unchanged.

In this embodiment, the video data in the subfields 411 to 416 are sequentially outputted to the spatial light modulation device 200, the output order however is not limited.

In these embodiments, the binary input digital video data is first split into intensity binary data, corresponding to the subfields. Then the intensity data are converted into non-binary data. Alternately, it is also feasible to convert the binary input digital video data into non-binary data and then split and allocate the non-binary data to each of the subfields.

Further, in these embodiments, all bits in the binary input digital video data are split into the subfields in a single operation. It is also possible to apply an alternate processes by first applying a same process described above to split and covert part of the input digital video data. In carrying out the process of splitting the input digital video data, it is possible to produce non-binary data having a plurality of differently weighed bit rows corresponding to the subfields, allowing reduction in the number of bits of the non-binary data corresponding to the subfields.

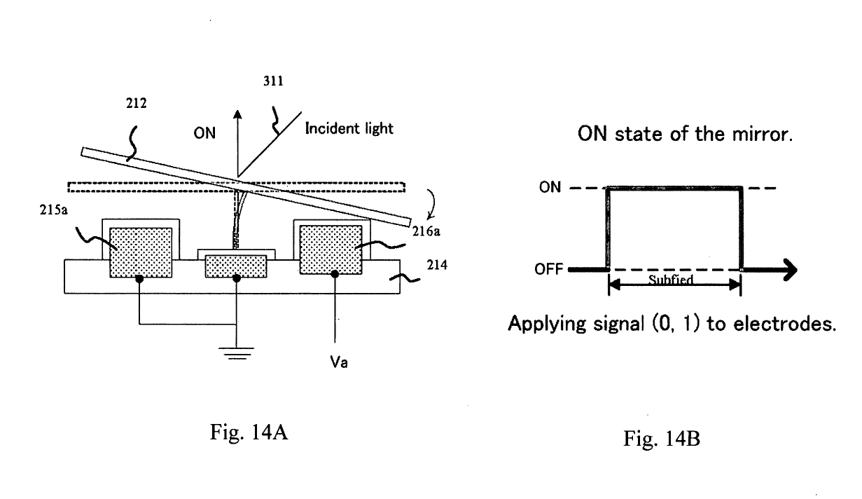

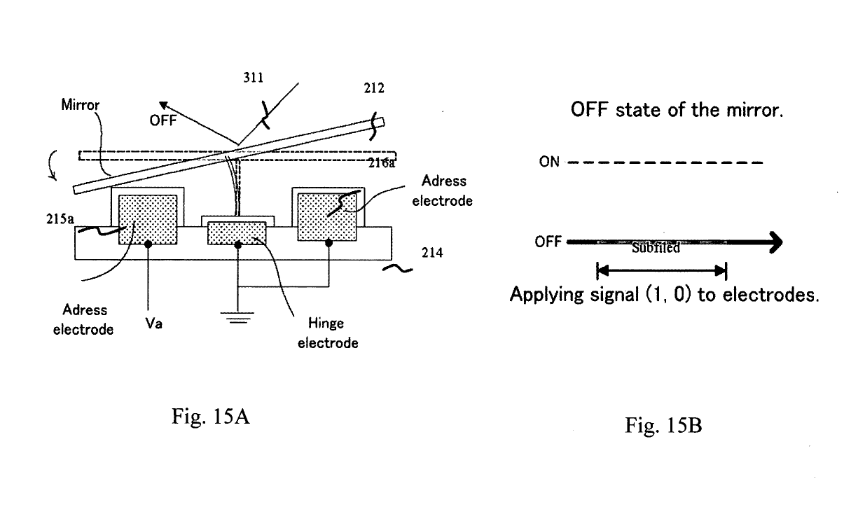

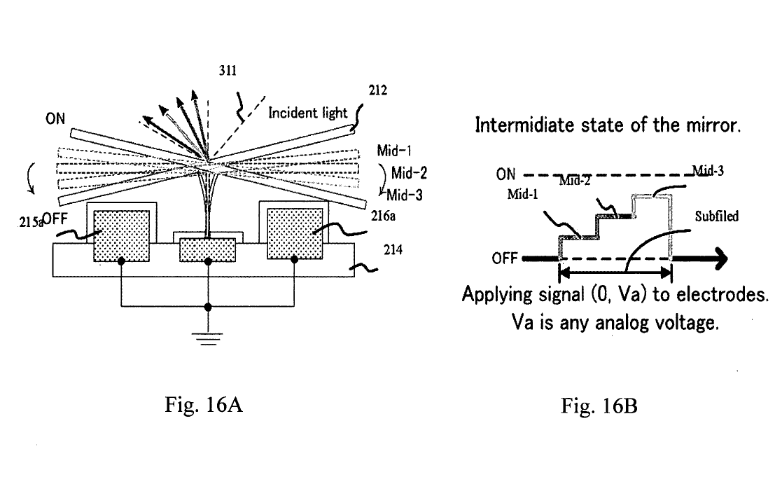

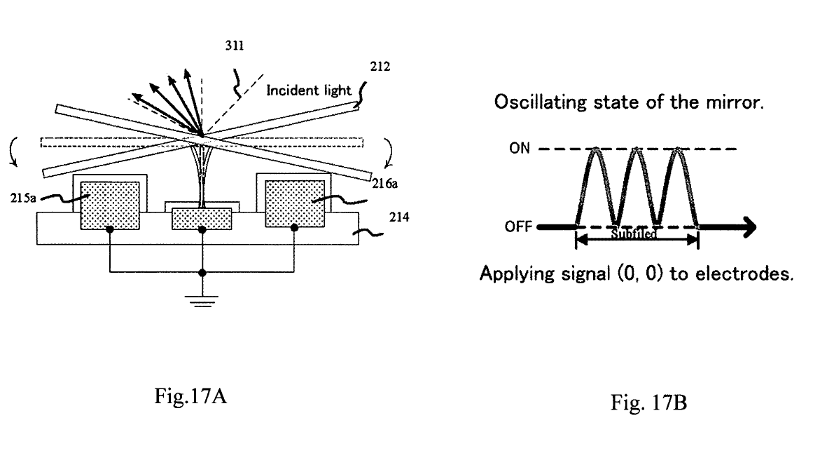

In the above embodiments, the description has been made with reference to the spatial light modulation device 200 having the two deflection states, ON and OFF, illustrated in FIG. 6, it is also possible to use a differently controlled spatial light modulation device 200 having more deflection states than controlling the mirror 212 at the ON and OFF positions shown in FIGS. 14A and 14B respectively. According to FIGS. 15A and 15B, the mirror 212 of the SLM may also be controlled to operate in the intermediate deflection states (FIGS. 16A and 16B or FIGS. 17A and 17B). By using such a spatial light modulation device to control the mirror to operate in these intermediate deflection states allows the image display to achieve more complex grayscales.

FIGS. 16A and 16B show an example of the intermediate deflection states where the mirror 212 is controlled by the deflection control voltage Va in each subfield that has multiple levels. These levels represented by Mid-1, Mid-2, and Mid-3, are control voltages in the range between the ON and OFF voltages.

FIGS. 17A and 17B show an example of the intermediate deflection states where the mirror 212 are controlled to oscillate by the deflection control voltage Va in each subfield with the voltage Va in a range between the ON and OFF voltages.

The configuration of the projection display apparatus is not limited to the configuration having one spatial light modulation device (SLM) 200 as in the projection display apparatuses 100 and 101 described above. The display system may be configured with a plurality of spatial light modulation devices (SLMs) 200.

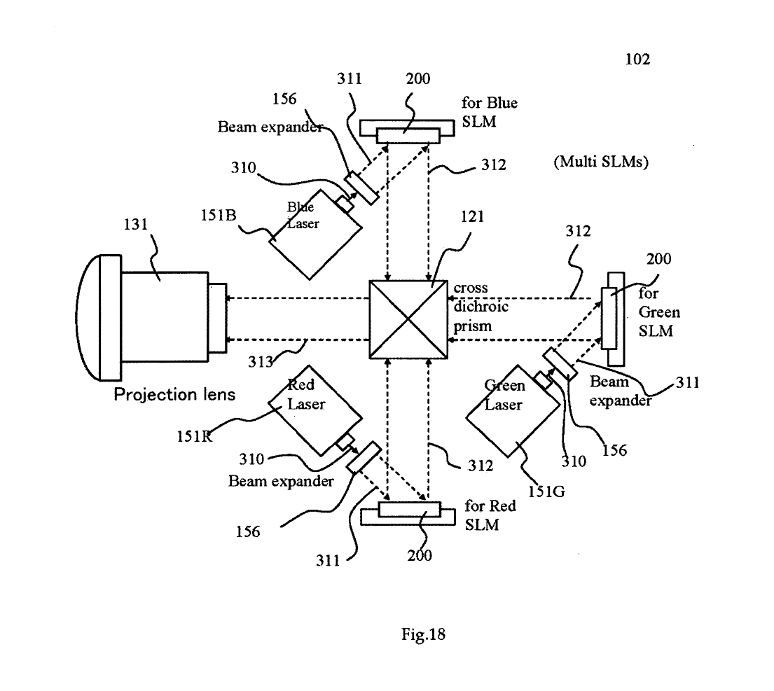

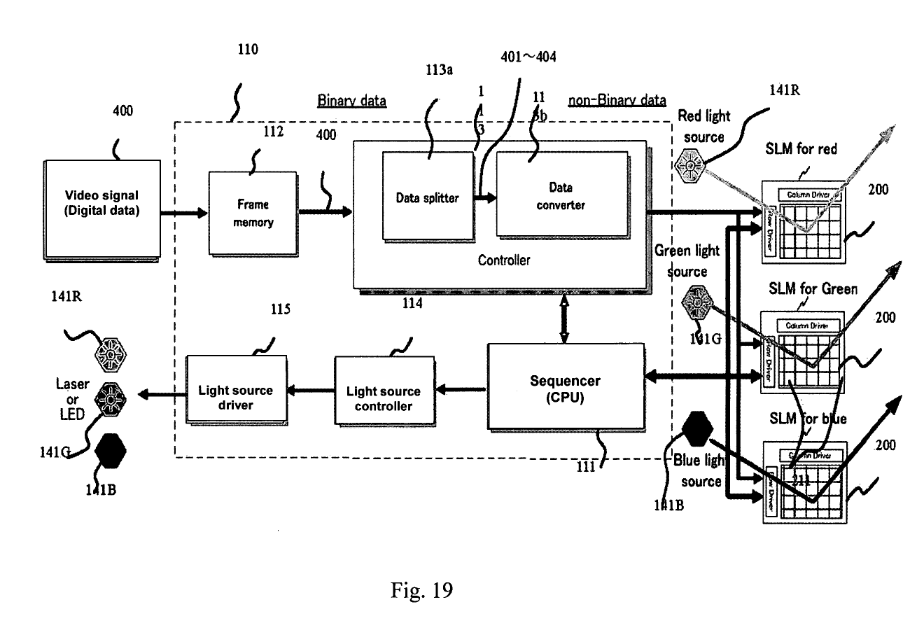

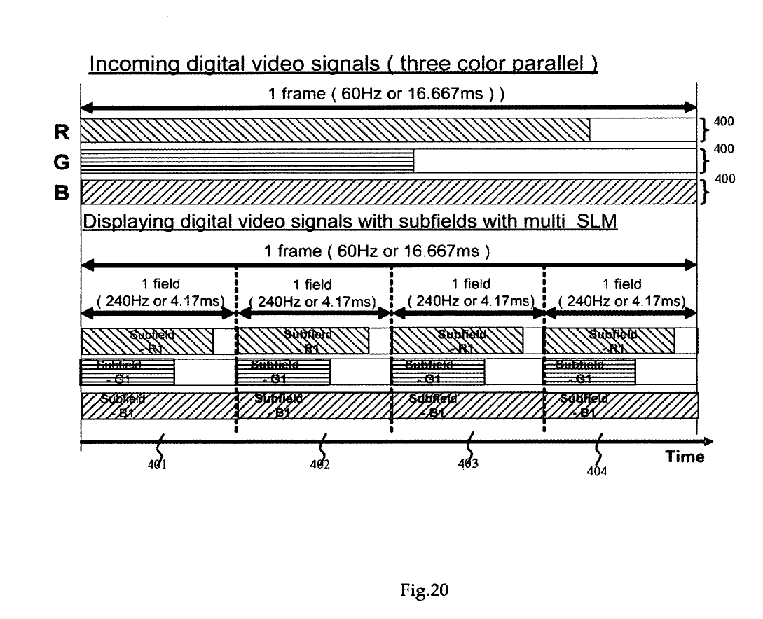

FIG. 18 is a system diagram for presenting a conceptual view for showing an exemplary configuration of a projection display apparatus 102 having a plurality of spatial light modulation devices (SLMs) 200. FIG. 19 is a block diagram showing an exemplary configuration of the control system of the projection display apparatus 102. FIG. 20 is a diagram to illustrate the control concepts as an example of operating the projection display apparatus 102.

The projection display apparatus 102 includes a plurality of spatial light modulation devices (SLMs) 200 corresponding to a red laser light source 151R, a green laser light source 151G, and a blue laser light source 151B. The display system further includes the light beam diffusers 156, a cross dichroic prism 121, a projection lens 131, and a control unit 110 that controls the above components.

The red laser light source 151R emits red illumination light 310, which is processed into an incident light 311 with a larger diameter through the light beam diffuser 156. The incident light 311 is reflected off the spatial light modulation device (SLM) 200 and incident on the cross-dichroic prism 121 as reflected light 312. The SLM 200 is specifically provided for modulating the red laser light source 151R.

Similarly, the green laser light source 151G emits green illumination light 310, which is processed into incident light 311 having a larger diameter through the light beam diffuser 156. The incident light 311 is reflected off the spatial light modulation device (SLM) 200 and incident on the cross-dichroic prism 121 as reflected light 312. The SLM device 200 is provided specifically for modulating the green laser light source 151G.

Similarly, the blue laser light source 151B emits blue illumination light 310, which is processed into incident light 311 with a larger diameter through the light beam diffuser 156. The incident light 311 is reflected off the spatial light modulation device (SLM) 200 and incident on the cross-dichroic prism 121 as reflected light 312. The SLM 200 is specifically provided for modulating the blue laser light source 151B and incident on the cross-dichroic prism 121 as reflected light 312.

The red, green, and blue reflected light beams 312 incident on the cross dichroic prism 121 are combined into one projection light 313 and projected through the projection lens 131.

In this case, the red laser light source 151R, the green laser light source 151G, and the blue laser light source 151B have the flexibility for modulating and transmitting the light independently in each subfield.

FIG. 19 shows a light source driver 115 in the control unit 110 to control the ON/OFF switches of the plurality of the laser light sources. These light sources include the red laser light source 151R, the green laser light source 151G, and the blue laser light source 151B. The light source can be flexibly controlled to project lights of these different colors either simultaneously or independent from each other.

FIG. 20 shows a plurality of subfields 401 to 404 generated by splitting one frame of input digital video data 400. The input video signal may include signals for controlling and displaying the red laser light source 151R, the green laser light source 151G, and the blue laser light source 151B. The control signals enable the synchronization of the beginning of light emission time with the end of light emission time assigned for each color in different subfields with the light emission duration corresponding to the light intensity as required by the input video data. Since the proportions of the R/G/B intensity levels are substantially the same in each of the subfields 401 to 404, in one frame of the original input digital video data 400, the image quality of the video projected by using the projection light 313 is improved.

According to the invention, there is provided color display technology by which excellent color image display can be achieved without color breakup. Although the present invention has been described in terms of the presently preferred embodiment, it is to be understood that such disclosure is not to be interpreted as limiting. Therefore, the invention is not limited to the configurations illustrated in the above embodiments, but various changes can of course be made thereto to the extent that they do not depart from the spirit of the invention. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A display method using a plurality of subfields, the method comprising the step of:
splitting image data into N (natural number) segments and distributing the intensity information on the image data in such a way that in a plurality of subfields that form a one-frame display period, the integrals of display light to be displayed in M (M (natural number)≧2) subfields are substantially the same, wherein in the splitting and distributing step, each of at least M split data has the LSB (least significant bit) is equal to the weight of the bit of the image data having the weight of the bit close to the (N−1).

2. The method for displaying image data according to claim 1, wherein in the splitting and distributing step, each of at least M split data has data values equal to the superior bits of the image data, the LSB (least significant bit) of the M split data is the bit of the image data having the weight of the bit close to the (N−1).

3. The method for displaying image data according to claim 1, wherein in the splitting and distributing step, the intensity information to be distributed to each of the subfields is converted into data containing a bit row formed of bits having the same weight, a successive part of the bits having the same value, and the converted intensity information is distributed to each of the subfields.

4. The method for displaying image data according to claim 1, wherein:
in the splitting and distributing step, when the intensity information on the image data is distributed to S (natural number) subfields, the intensity information is split into at least 2ⁿ (n is an integer); and
when the split intensity information is distributed to the S subfields, the n is an integer next to log₂S.

5. The method for displaying image data according to claim 1, wherein the integrals of the display light in the subfields having substantially the same integral of the display light are greater than the integrals of the display light in the other subfields.

6. A color display method using a plurality of subfields for display light having at least two colors, the method including the step of:
splitting image data on each of the colors into N (natural number) segments and distributing the intensity information on the image data in such a way that in a plurality of subfields that form a one-frame display period, the integrals of the display light to be displayed in M (M (natural number)≧2) subfields are substantially the same;
wherein in the splitting and distributing step, each of at least M split data has the LSB (least significant bit) is equal to the weight of the bit of the image data having the weight of the bit close to the (N−1); and
the intensity information on each of the colors is distributed in such a way that the proportion of the integrated amount of the display light to be displayed in the M subfields for each of the colors is substantially the same as the proportion of the intensity information on each of the colors in the image data.

7. The method for displaying image data according to claim 6, wherein in the splitting and distributing step, each of at least M split data has data values equal to the superior bits of the image data, the LSB (least significant bit) of the M split data is the bit of the image data having the weight of the bit close to the (N−1).

8. The method for displaying image data according to claim 6, wherein in the splitting and distributing step, the intensity information to be distributed to each of the subfields is converted into data containing a bit row formed of bits having the same weight, a successive part of the bit row having the same bit value, and the converted intensity information is distributed to each of the subfields.

9. The method for displaying image data according to claim 6, wherein in the splitting and distributing step, when the intensity information on the image data is distributed to S subfields, the intensity information is split into at least 2ⁿ (n is an integer) and when the split intensity information is distributed to the S subfields, the n is an integer next to log₂S.

10. A display apparatus comprising:
a light source that produces illumination light;
a deflection mirror device that modulates the illumination light from the light source; and
a controller that uses intensity information on image data to control the deflection mirror device, the controller having a function of distributing the intensity information in such a way that in a plurality of subfields that form a one-frame display period, the integrals of projection light to be displayed in M (M (natural number)≧2) subfields are substantially the same, the controller further including a data splitter that splits the image data in such a way that each of at least (N−1) (N (natural number)≧2) split data has the LSB (least significant bit) is equal to the weight of the bit of the image data having the weight of the bit close to the N.

11. The display apparatus according to claim 10, wherein the controller further including a data splitter that splits the image data in such a way that each of at least (N−1) split data has data values equal to the superior bits of the image data, the LSB (least significant bit) of (N−1) split data is the bit of the image data having the weight of the bit close to the N.

12. The display apparatus according to claim 10, wherein the controller further includes a data converter that converts the intensity information on the image data to be distributed to each of the subfields into data containing a bit row formed of bits having the same weight, a successive part of the bit row having the same value.

13. The display apparatus according to claim 10 further comprising:
color filters disposed along the light path of projection light or illumination light, the color filters having functions of filtering a plurality of colors in such a way that the projection light is changed in a time series manner, and
a color filter controller that controls the timing at which the color of the projection light is changed.

14. The display apparatus according to claim 10, wherein:
the light source is a variable-power light source, such as a laser, and
the controller converts the distributed image data according to the intensity of the illumination light in such a way that the integrals of the projection light to be displayed in the subfields are fixed.

15. The display apparatus according to claim 10, wherein:
the deflection mirror device has at least three deflection states, and
the controller converts the distributed image data according the deflection state of the deflection mirror device in such a way that the integrals of the projection light to be displayed in the subfields are fixed.

16. A method for displaying image data using a plurality of subfields, the method including the step of:
distributing the intensity information on the image data in such a way that in a plurality of subfields that form a one-frame display period, the integrals of display light to be displayed in at least two of the subfields are substantially the same.

17. The method for displaying image data according to claim 16, wherein in the splitting and distributing step, each of at least two split data has data values equal to the superior bits of the image data.
